(19) United States
(12) Patent Application Publication
(10) Pub. No.: US 2024/0102442 A1
(43) Pub. Date: Mar. 28, 2024

(54) GENERATOR FOR A WIND POWER INSTALLATION FOR GENERATING ELECTRICAL ENERGY FROM KINETIC ENERGY, WIND POWER INSTALLATION, AND USE OF A PLURALITY OF VORTEX GENERATORS FOR ARRANGEMENT ON AN OUTER PERIPHERAL SURFACE PORTION OF A GENERATOR FOR A WIND POWER INSTALLATION

(71) Applicant: Wobben Properties GmbH, Aurich (DE)

(72) Inventors: Hussam Daboul, Südbrookmerland (DE); Wojciech Giengiel, Aurich (DE); Matthias Arnold, Aurich (DE)

(21) Appl. No.: 18/473,961

(22) Filed: Sep. 25, 2023

(30) Foreign Application Priority Data
Sep. 26, 2022 (EP) 22197699.6

(51) Int. Cl. F03D 1/06; F03D 80/60

(52) U.S. Cl. CPC F03D 1/06495; F03D 80/60; F05B 2240/3062

(57) ABSTRACT

A generator for a wind power installation for generating electrical energy from kinetic energy comprises an outer peripheral surface portion, the outer peripheral surface portion having: an incident-flow surface portion against which wind flows in an incident-flow direction in the installed state of the generator, the incident-flow surface portion extending along an axial direction and orthogonally thereto along a peripheral direction, and a cooling surface portion, designed for cooling the generator and disposed downstream of the incident-flow surface portion in the installed state in the incident-flow direction, the cooling surface portion extending along an axial direction and orthogonally thereto along a peripheral direction, wherein one or more vortex generators for passive cooling of the generator are arranged in a region of the outer peripheral surface portion, in particular in a region of the incident-flow surface portion and/or in a region of the cooling surface portion.

### BACKGROUND

### Technical Field

Embodiments of the invention relate to a generator for a wind power installation for generating electrical energy from kinetic energy, the generator comprising an outer peripheral surface portion, the outer peripheral surface portion having an incident-flow surface portion against which wind flows in the incident-flow direction in the installed state of the generator, the incident-flow surface portion extending along an axial direction and orthogonally thereto along a peripheral direction, and a cooling surface portion designed for cooling the generator and disposed downstream of the incident-flow surface portion in the installed state in the incident-flow direction, the cooling surface portion extending along an axial direction and orthogonally thereto along a peripheral direction.

Embodiments of the invention also relate to a wind power installation. Embodiments of the invention further relate to a use of a plurality of vortex generators for arrangement on an outer peripheral surface portion of a generator for a wind power installation.

### Description of the Related Art

For an efficient operation of wind power installations, in particular also of generators of wind power installations, over a long service life, the cooling of the generators of wind power installations is essential. It is known to passively cool generators over their outer peripheral surface, at least in portions. Among other things, wind flowing around the wind power installation is used for passive cooling. However, due to the limited outer peripheral surface of generators, the cooling capacity of this type of passive cooling is restricted. It is therefore known to actively cool generators by using fans and the like. Active cooling, however, has the disadvantage that it complicates the construction of the generator and requires maintenance.

### BRIEF SUMMARY

Some embodiments provide a generator which overcomes the above-mentioned disadvantages. In particular, some embodiments provide a generator which enables improved, in particular more efficient and more robust, and at the same time low-maintenance and simple cooling of generators, which is particularly cost-effective.

According to a first aspect, an embodiment includes a generator described at the outset, wherein one or more vortex generators for passive cooling of the generator are arranged in a region of the outer peripheral surface portion, in particular in a region of the incident-flow surface portion and/or in a region of the cooling surface portion. It is preferably provided that one or more vortex generators for passive cooling of the generator are arranged on the incident-flow surface portion and/or on the cooling surface portion.

The arrangement of one or more vortex generators in the region of the outer peripheral surface portion, in particular on the outer peripheral surface portion of a generator for a wind power installation significantly increases the efficiency of passive cooling by the wind. By placing vortex generators in the region of the outer peripheral surface portion, in particular on the outer peripheral surface portion, particularly preferably on the cooling surface portion and/or in front of the cooling surface portion and/or on the incident-flow surface portion, the turbulence and thus the heat transfer coefficient is considerably increased. This effect is based fundamentally on the fact that the vortex generators generate a rotating vortex system or stronger turbulences in its wake, which leads to a mixing of the thermal boundary layer directly at or in the immediate vicinity of the surface to be cooled, for example the outer peripheral surface of the generator, there in particular the cooling surface portion.

Due to the improved heat transfer in the region of the outer peripheral surface portion, in particular on the outer peripheral surface portion, particularly preferably on the cooling surface portion, the generator can be operated cooler and thus more efficiently with the same power. This results in a direct increase in the energy yield. In addition, the use of vortex generators as described herein allows a reduction of the required active cooling, which leads to a reduction of costs and internal consumption.

It is to be understood that the outer peripheral surface portion, and in particular the incident-flow surface portion and/or the cooling surface portion, is preferably not a part or an element of the nacelle and/or is not formed by the nacelle. It is further preferred that the outer peripheral surface portion, and in particular the incident-flow surface portion and/or the cooling surface portion, is not a part or an element of the spinner or the like, or is formed by the spinner. Preferably, the generator is not arranged inside the nacelle, in particular also not partly inside the nacelle, in the installed state or in the operating state.

In particular, it is provided that the generator has, in relation to an axis of rotation of the generator, an outer diameter which is larger than an outer diameter of the nacelle. Preferably, it is provided that the generator in the installed state or in the operating state is arranged in the axial direction between a spinner of the wind power installation and the nacelle of the wind power installation. In a preferred manner, it is provided that the generator is arranged adjacently to the nacelle on the front side in the installed state or in the operating state.

The region of the outer peripheral surface portion, in particular the region of the incident-flow surface portion and/or the cooling surface portion, is preferably a space in the immediate vicinity of the outer peripheral surface portion, in particular a space in the immediate vicinity of the incident-flow surface portion and/or a space in the immediate vicinity of the cooling surface portion. In particular, the region of the outer peripheral surface portion, in particular the region of the incident-flow surface portion and/or the cooling surface portion, can be an annular region which encloses the outer peripheral surface portion, in particular the incident-flow surface portion and/or the cooling surface portion. It is preferably provided that the region of the outer peripheral surface portion, in particular the region of the incident-flow surface portion and/or the cooling surface portion, is peripherally bounded on the inside by the outer peripheral surface portion, in particular the incident-flow surface portion and/or the cooling surface portion, in the radial direction.

The outer peripheral surface portion, in particular the incident-flow surface portion and/or the cooling surface portion, can form an annular or part-annular peripheral surface. Preferably, the annular or part-annular peripheral surface is flat. It may be preferred that the outer peripheral surface portion, in particular the incident-flow surface portion and/or the cooling surface portion, is profiled. In particular, it may be provided that the outer peripheral surface portion, in particular the incident-flow surface portion and/or the cooling surface portion, has elevations and/or recesses. The protrusions extend radially outward and the recesses extend radially inward. In particular, it is preferred that the outer peripheral surface portion, in particular the incident-flow surface portion and/or the cooling surface portion, has a rib profile or forms a rib profile. Preferably, the rib profile comprises at least two ribs, wherein adjacent ribs are arranged spaced apart from each other so that a gap is formed between the adjacent ribs, through which gap the wind diverted for cooling is guided. The gap can be formed as a groove, the groove base of which limits a flow inwards in the radial direction. Additionally or alternatively, it may be preferred that the gap is formed as a through-channel, which allows a radial flow through the gap inwards.

A vortex generator is also known as a swirl generator or turbulence generator. A vortex generator is a flow-guide element designed to generate a wake vortex within or at a fluid-dynamic boundary layer, which stabilizes the boundary layer against turbulent separations and generates an increased mixing of the fluid layers.

A vortex generator can have different shapes. For example, rectangular vortex generators are known. Furthermore, a vortex generator can be triangular in shape. Pointed arch-shaped or ogive vortex generators are also known. Additionally or alternatively, it may be preferred that the vortex generators have an elliptical and/or parabolic shape. Furthermore, it may be preferred that vortex generators are convex and/or concave in shape. In particular, vortex generators can also be parabolic in shape.

Vortex generators typically extend longitudinally between a first end and a second end or between a first edge and a second edge with a length. Preferably, vortex generators are arranged in the installed or operating state such that the wind used for passive cooling of the generator flows against the first end or the first edge of the vortex generator and the wind flows off the second end or the second edge of the vortex generator. The first end or the first edge is then called the leading end or leading edge and the second end or the second edge is called the trailing end or trailing edge. Furthermore, it is preferred that vortex generators extend orthogonally to the longitudinal direction, for example in the installed state or operating state of the generator in relation to the axis of rotation of the generator in the radial direction, between a base side of the vortex generator and a head side of the vortex generator with a height. It is further preferred that vortex generators extend orthogonally to the longitudinal direction, for example in the installed state or operating state of the generator with respect to the axis of rotation of the generator in the peripheral direction, over a width between a first and second side face of the vortex generator.

The side faces can be designed to guide the incident air from the leading edge to the trailing edge. It may be preferred that the side faces have no curvature. Additionally or alternatively, it may be preferred that the side faces are curved in portions. Preferably, the side faces are bulbous. In particular, it is preferred that the side faces are arranged inclined relative to each other.

By means of the base side, vortex generators are attached, for example to the outer peripheral surface of the generator or the air guide unit. It is preferred that the one or more vortex generators extend radially outwards with the base side starting from the outer peripheral surface portion, in particular from the incident-flow surface portion and/or from the cooling surface portion. It may be preferred that the outer peripheral surface portion, in particular the incident-flow surface portion and/or the cooling surface portion, integrally form the one or more vortex generators. Additionally or alternatively, it is preferred that the one or more vortex generators are connected by means of the base side to the outer peripheral surface portion, in particular the incident-flow surface portion and/or the cooling surface portion, in an integrally bonded and/or form-fitting and/or frictionally engaged manner or are designed for an integrally bonded and/or form-fitting and/or frictionally engaged connection to the outer peripheral surface portion, in particular the incident-flow surface portion and/or the cooling surface portion. Preferably, the vortex generators can be formed by the generator plates. Additionally or alternatively, the vortex generators are preferably connected to the cooling surface portion in a screw-locking and/or riveting manner.

It is to be understood that it is preferred that the width and/or length of the vortex generators can vary over the height of the vortex generators. In particular, it may be preferred that the width and/or length of the vortex generators decreases from the base side towards the head side.

Vortex generators preferably comprise one or more vanes and/or a base part forming the base side. In particular, the vane(s) is/are intended to extend from the base part to the head side. Preferably, a vortex generator comprises two or more co-rotating vanes and/or two or more counter-rotating vanes. Preferably, the base part is configured for connection to the outer peripheral surface portion, in particular the incident-flow surface portion and/or the cooling surface portion. The vane may be twisted.

For example, the vortex generators may be made of plastic and/or metal. In particular, the vortex generators may comprise plastic and/or metal elements.

Preferably, the vortex generators extend from the cooling surface portion. In particular, it is provided that the vortex generators extend from the cooling surface portion with a main extent in a radial direction. It is additionally or alternatively preferred that the vortex generators extend from the cooling surface portion with a main extent in a peripheral direction.

The size of the vortex generators depends on the geometry of the generator. In particular, the size of the vortex generators depends on whether the generator has an air guide unit and/or cooling fins for cooling. Preferably, the size of the vortex generators can be freely selected if the generator has neither an air guide unit nor cooling fins.

The distance between adjacent vortex generators preferably corresponds to the single height or at least the single height of the adjacent vortex generators. It may also be preferred that the distance between adjacent vortex generators corresponds to a double, triple, quadruple or multiple height of the adjacent vortex generators. It may also be preferred that the distance between adjacent vortex generators corresponds to at least twice, three times, four times or more the height of the adjacent vortex generators and/or at most twice, three times, four times or more the height of the adjacent vortex generators. As a rule, a distance between adjacent vortex generators is not greater than twice the height of the adjacent vortex generators, as this then leads to a weakening of the additional cooling effect. It may also be preferred that the distance between adjacent vortex generators is 25%, 50% or 75% of the height of the adjacent vortex generators. It may also be preferred that the distance between adjacent vortex generators is at least 0%, 25%, 50%, 75% or 100% and/or at most 0%, 25%, 50% 75% or 100% of the height of the adjacent vortex generators.

If the generator has vortex generators in combination with cooling fins, the spacing of the adjacent vortex generators and the height of the vortex generators is preferably such that the number of vanes of the vortex generators is an integer division or multiple of the number of cooling fins. This has the effect that an integer number of vortices generated by the vortex generators can be directed into each gap between two cooling fins. This is inherent when the vortex generators are arranged in a gap between two cooling fins.

Embodiments of the generator may be preferred that provide for a multi-row arrangement of the vortex generators. In particular, in a multi-row arrangement of the vortex generators, the vortex generators are arranged one behind the other in the axial direction and/or radial direction and/or peripheral direction. In a multi-row arrangement of the vortex generators, the vortex generators arranged one behind the other are preferably arranged in such a way that the flow redirection by the vortex generators causes co-rotating vortices. Co-rotating vortices are vortices that swirl or rotate in the same direction. Furthermore, it may be preferred that in a multi-row arrangement of the vortex generators, the vortex generators of the individual rows are arranged offset to each other in the peripheral direction and/or in axial direction and/or in radial direction. In particular, it is preferred that in a multi-row arrangement of the vortex generators, the vortex generators of the individual rows can be designed with a different shape and/or a different size.

In principle, vortex generators of such generators can be arranged at different preferred distances from each other. In particular, it may be preferred that vortex generators are arranged at different preferred distances from each other in the peripheral direction. Additionally or alternatively, it may be preferred that vortex generators are arranged at different preferred distances from one another in the axial direction or longitudinal direction.

In particular, it may be preferred that the vortex generators are arranged in an overlapping manner. In this case, overlapping means that the distance between the vortex generators in the flow direction of the wind is smaller than the length of the vortex generators. Accordingly, in an overlapping arrangement, vortex generators are arranged in several rows, at least in two rows, so that the row of vortex generators arranged downstream in the direction of flow begins before the row of vortex generators arranged upstream in the direction of flow ends. Overlapping means in particular that two or more rows of vortex generators are arranged one behind the other in the axial direction or longitudinal direction. In the overlapping arrangement of the vortex generators, it is provided that the first end or the first edge of the vortex generators of a downstream row are arranged in such a way that they are positioned between the first end or the first edge and the second end or the second edge of the vortex generators of the upstream row. As a result, when the vortex generators are arranged in an overlapping manner orthogonally to the direction of flow of the wind, for example in the peripheral direction, vortex generators of the upstream row and the downstream row are arranged alternately and the vortex generators of the upstream row and the downstream row are arranged in the direction of flow, for example in the axial direction or longitudinal direction of the vortex generators, i.e., the extent of the vortex generators of the downstream row begins already before the extent of the vortex generators of the upstream row ends.

Preferably, in this embodiment, adjacent vortex generators are arranged at a distance from each other of at least 2 times the height of the vortex generators and/or at most 5 times the height of the vortex generators, in particular are arranged at a distance from each other in the peripheral direction and/or axial direction. However, larger distances between adjacent vortex generators may also be preferred.

It is preferred that the cooling surface portion has a plurality of cooling fins having a main extent in an axial direction and being spaced apart in a peripheral direction orthogonal to the axial direction. In particular, cooling fins arranged adjacently to each other in a peripheral direction form a gap for cooling the generator. Preferably, one or more vortex generators are arranged within the gap on at least one of the cooling fins defining the gap for improved cooling of the generator. Additionally or alternatively, it is provided that the vortex generators are arranged on an outer peripheral surface of at least one of the cooling fins.

The cooling surface portion extends in the axial direction with a cooling unit length between a first and second end. The axial direction preferably corresponds to an orientation of the axis of rotation of the generator. In the peripheral direction, orthogonal to the axial direction, the cooling surface portion extends in particular with a cooling unit width between a first and a second side. Orthogonal to the axial direction and peripheral direction, the cooling surface portion extends between a cooling unit inner face and the cooling unit outer face with a cooling unit height.

In the present text, position and orientation specifications, such as “above” and “below” or “outward” and “inward” or “radial”, “axial”, “longitudinal” or “peripheral”, refer to the operating state or installation state of a wind power installation, in particular to the axis of rotation of the generator, unless otherwise stated. In particular, it is to be understood that an axial direction or longitudinal direction corresponds substantially to an alignment or orientation of the axis of rotation of the generator.

During transport and/or maintenance and/or servicing work on the wind power installation and/or the generator and/or the air cooling device and/or tower, the alignment of the axes, in particular with respect to each other, may deviate from the alignment of the axes in the operating state of the wind power installation.

Preferably, the cooling unit height is smaller than the cooling unit width. It is also preferred that the cooling unit width is smaller than the cooling unit length. Preferably, the cooling unit is formed as a part-annular cooling segment. It may also be preferred that the cooling surface portion comprises one or more part-annular cooling segments.

The cooling surface portion is preferably flat. It may also be preferred that the cooling surface portion is profiled. In particular, the cooling surface portion may have protrusions or extensions extending outwards radially and/or recesses extending inwards radially. In particular, the cooling surface portion may have a ribbed and/or corrugated and/or tubular profile and/or channel-shaped profile.

In the operating state, the cooling surface portion may be arranged on an outer side of the generator. It may be preferred that the cooling surface portion is formed on a housing of the generator or is the housing of the generator. The cooling surface portion is preferably at least a portion of an outer peripheral surface, in particular an outer peripheral surface of a generator. For cooling the generator, it is preferably thermally coupled to the cooling surface portion. In a preferred manner, the nacelle forms the cooling surface portion or accommodates it on the outer side. In particular, it is provided that the nacelle comprises one or more openings in which the cooling surface portion is arranged. The one or more openings may be annular or part-annular.

In particular, an outer side of a stator and/or of a generator may form or may be the cooling surface portion.

For further advantages, embodiments and design details of this aspect and developments thereof, reference is also made to the following description of the corresponding features of the respective other aspects and their developments.

According to a preferred embodiment of the generator, it is provided that the cooling surface portion is offset in a radial direction, in particular offset inwards, with respect to the incident-flow surface portion. It is to be understood that the cooling surface portion is preferably further inwards in relation to the incident-flow surface portion in the radial direction. This means in particular that the transition between the incident-flow surface portion and the cooling surface portion is stepped. Such an embodiment is created, for example, by generator support structures that form an incident-flow surface portion in front of the surface of the generator to be cooled, the cooling surface portion.

Alternatively, according to a preferred embodiment of the generator, it is provided that the cooling surface portion and the incident-flow surface portion are not offset from each other in the radial direction. In particular, this embodiment provides that the cooling surface portion and the incident-flow surface portion extend within the same plane. It may be preferred that the cooling surface portion and the incident-flow surface portion in this embodiment form a unit in which the cooling surface portion and the incident-flow surface portion transition smoothly into one another.

According to a further preferred development, the generator has an air guide unit which is arranged in the region of the incident-flow surface portion and/or in the region of the cooling surface portion, the air guide unit being designed to deflect the wind in the direction of the cooling surface portion, in particular in a radial direction inwards towards the cooling surface portion. The air guide unit is preferably designed in such a way that it extends in the peripheral direction over the periphery of the incident-flow surface portion and/or the cooling surface portion. In particular, it is preferably provided that the air guide unit is arranged in the region of the outer peripheral surface portion, in particular in the region of the incident-flow surface portion and/or in the region of the cooling surface portion. Additionally or alternatively, it is preferred that the air guide unit is arranged on the outer peripheral surface portion, in particular on the incident-flow surface portion and/or on the cooling surface portion.

The air guide unit preferably has a leading edge and a trailing edge, wherein the air guide unit in the installed state is arranged in such a way that the leading edge is arranged upstream with respect to the trailing edge in relation to the oncoming wind. It is to be understood that the air guide unit extends longitudinally with a length between the leading edge and the trailing edge. Additionally or alternatively, it is provided that the air guide unit extends in the radial direction with a height between the leading edge and the trailing edge. Furthermore, it is additionally or alternatively preferred that the air guide unit extends in the peripheral direction with a width.

This preferred arrangement of the one or more vortex generators on the air guide unit significantly increases the efficiency of passive cooling by the wind. By attaching vortex generators to the air guide unit, the turbulence and thus the heat transfer coefficient is significantly increased. This effect is based fundamentally on the fact that the vortex generators create a rotating vortex system or stronger turbulences in their wake, which leads to a mixing of the thermal boundary layer directly or in the immediate vicinity of the surface to be cooled, for example the outer peripheral surface of the generator, there in particular the cooling surface portion.

Due to the improved heat transfer in the region of the outer peripheral surface portion, in particular on the outer peripheral surface portion, particularly preferably on the cooling surface portion, the generator can be operated cooler and thus more efficiently with the same power. This results in a direct increase in the energy yield. In addition, the use of vortex generators as described herein allows a reduction of the required active cooling, which leads to a reduction of costs and inherent consumption.

The air guide unit is preferably designed to guide the wind for air cooling in the radial direction inwards towards the cooling surface portion in the operating state of the wind power installation. For this purpose, the air guide unit is preferably arranged inclined relative to the incident-flow surface portion and/or the cooling surface portion. In particular, the air guide unit is arranged such that these form one or more air guide channels which guide the wind for air cooling in the radial direction inwards towards the cooling surface portion. In particular, the one or more air guide channels are aligned with the wind direction in the operating state of the wind power installation, so that the wind flowing around the wind power installation enters the one or more air guide channels.

It may be preferred that the air guide unit, which extends outwards from the cooling surface portion radially, is arranged at a distance from the incident-flow surface portion and/or the cooling surface portion. In particular, the air guide unit may be arranged spaced apart from the incident-flow surface portion and/or the cooling surface portion radially. In particular, the air guide unit has a distance in the radial direction which corresponds to at least 0%, 1%, 5%, 10%, 20%, 30%, 40%, 50%, 100%, 150% or 200% of the cooling unit length and/or corresponds to at most 0%, 1%, 5%, 10%, 20%, 30%, 40%, 50%, 100%, 150% or 200% of the cooling unit length. The air guide unit distance is equal to at least 0 mm, 50 mm, 100 mm, 150 mm, 200 mm, 300 mm or more and/or at most 0 mm, 50 mm, 100 mm, 150 mm, 200 mm or 300 mm. The distance is preferably the distance of the trailing edge of the air guide unit to the outer face of the leading face portion and/or the cooling face portion.

Alternatively, it may be preferred that the incident-flow surface portion and/or the cooling surface portion integrally forms the air guide unit. In particular, it is also preferred that the air guide unit is attached to the incident-flow surface portion and/or the cooling surface portion. Preferably, the air guide unit is connected to the incident-flow surface portion and/or the cooling surface portion in a frictionally engage and/or integrally bonded and/or form-fitting manner. In particular, it may be preferred that the air guide unit is welded to the incident-flow surface portion and/or the cooling surface portion. Alternatively or additionally, it may be preferred to screw the air guide unit to the incident-flow surface portion and/or the cooling surface portion.

Furthermore, according to a preferred development, it is provided that the one or more vortex generators are arranged on the air guide unit. Preferably, the one or more vortex generators are arranged on a radially outer peripheral surface of the air guide unit. Additionally or alternatively, it may be preferred that the one or more vortex generators are arranged on a radially inner peripheral surface of the air guide unit. In particular, it is to be understood that the inner peripheral surface is inwards in radial direction with respect to the outer peripheral surface of the air guide unit.

According to a preferred embodiment of the air guide unit, it is provided that the air guide unit comprises a first air guide unit which, starting from the cooling unit outer face, extends outwards at an acute angle radially and/or forms with the cooling unit a converging first air guide channel, which is designed to guide the wind for air cooling radially inwards towards the cooling unit in the operating state of the wind power installation. Alternatively or additionally, it is preferably provided that the cooling unit has a plurality of cooling fins having a main extent in an axial direction and being spaced apart in a peripheral direction orthogonal to the axial direction, and the air guide device has a main extent substantially in the peripheral direction.

Preferably, the air guide unit is arranged in such a way that it extends outwards at an acute angle in the radial direction. An acute angle is between a minimum of 0° and a maximum of 90°, inclusive. In particular, the acute-angled arrangement of the air guide unit has the effect that the wind flowing in substantially axially in the operating state of the wind power installation is diverted inwards in the radial direction towards the cooling surface portion.

The air guide unit is preferably part-annular or annular. The air guide unit extends in the axial direction with a length, in the peripheral direction with a width and in the radial direction with a height. Preferably, the width is greater than the length and/or the height. Preferably, the air guide unit has a linear profile. In particular, a linear profile has no curvature. It may be preferred that the air guide unit has a curved profile and/or profile with edges. Preferably, the edge of the profile of the air guide unit has an edge length which preferably corresponds to at least 0% and at most 200% of the length of the cooling surface portion extending between a first end and a second end. In particular, the profile of the air guide unit may also be S-shaped. In particular, the profile of the air guide unit may have convex and/or concave profile portions. The height of the air guide unit corresponds to at least 0 mm, 50 mm, 100 mm, 150 mm, 200 mm, 300 mm or more and/or at most 0 mm, 50 mm, 100 mm, 150 mm, 200 mm or 300 mm. In particular, the height of the air guide unit in the radial direction corresponds at least to 0%, 1%, 5%, 10%, 20%, 30%, 40%, 50%, 100%, 150% or 200% of the cooling unit length and/or at most to 0%, 1%, 5%, 10%, 20%, 30%, 40%, 50%, 100%, 150% or 200% of the cooling unit length. The height of the air guide unit is preferably the distance between the leading edge and the trailing edge of the air guide unit.

If the generator has vortex generators in combination with an air guide unit, the height of the vortex generators is in particular smaller than half the distance between the air guide unit and the generator.

Preferably, the height of the vortex generators is less than ⅓ of the distance between the air guide unit and the generator. In particular, the height of the vortex generators is less than ⅓ of the distance between the air guide unit and the generator in the radial direction. Furthermore, it is preferred that the height of the vortex generators is less than ⅓ of the distance between the air guide unit and the generator in the axial direction.

Vortex generators with a greater height usually cause a weaker cooling effect. In particular for vortex generators with a greater height, it is therefore preferable if the vanes of the vortex generators are twisted.

Furthermore, according to a preferred development of the generator, it is provided that the one or more vortex generators are arranged upstream of the air guide unit in the incident-flow direction.

The arrangement of the vortex generators in front of, on top of or after the air guide unit can influence the position within the boundary layer of the cooled surface of the cooling surface portion at which the vortex generated by the vortex generators is located. The further forward the vortex generators are arranged, the deeper the vortex of the respective vortex generator is introduced by the air guide unit into the cooling surface portion, in particular the cooling fins of the surface of the cooling surface portion. This can support the heat dissipation from the generator and thus the cooling of the generator. This is particularly advantageous if the flow around the generator is highly turbulent, for example due to close flow separations, and thus results in good heat dissipation into the far field of the cooling surface portion. In addition, this positioning results in a strengthening of the flow around the air guide unit, as the vortex generators strengthen its aerodynamic boundary layer. In this preferred embodiment, however, it can be disadvantageous that a stronger damping of the vortices generated by the vortex generators results from the deflection with the air guide unit. Damping here means that the vorticity of the vortex structures generated by the vortex generators becomes weaker over the distance, or the vortices mix. This effect is called damping of the vortices and depends on whether the vortices can spread freely or are influenced by external pressure gradients or components.

According to a further preferred embodiment of the generator, it is provided that the one or more vortex generators are arranged downstream of the air guide unit in the incident-flow direction.

As already explained previously, the location of the vortex generators in front of, on top of or after the air guide unit can influence where the vortex generated by the vortex generators is located within the boundary layer of the cooled surface of the cooling surface portion. The further back the vortex generators are located, the higher will be the level at which the generated vortices remain in the boundary layer. This is advantageous if the flow is weakly turbulent or even permanently present, as then an improved heat exchange from the boundary layer into the free field is made possible. In this embodiment, however, it is important to note that the air guide unit can lead to flow separations, so that the vortex generators arranged behind the air guide unit are not exposed to the incident flow and accordingly cannot cool the generator.

If vortex generators are arranged both in front of and behind the air guide unit as well as additionally or alternatively on the air guide unit, this positioning of the vortex generators can direct the generated vortices into certain thermal boundary layers, for example into an area of weak temperature gradients, in order to increase the temperature gradient there and thus the cooling effect.

Furthermore, according to a preferred development of the generator, it is provided that the air guide unit is arranged in the region of a transition from the incident-flow surface portion and the cooling surface portion. It is to be understood that the incident-flow surface portion is preferably directly adjacent to the cooling surface portion. In particular, it is provided that the incident-flow surface portion transitions into the cooling surface portion. Preferably, the incident-flow surface portion transitions into the cooling surface portion in a continuous or stepped manner. In particular, the air guide unit is arranged in an end region of the incident-flow surface portion adjacent to an end region of the cooling surface portion and/or in an end region of the cooling surface portion adjacent to an end region of the incident-flow surface portion. This has the particular advantage that the wind flowing towards the cooling surface portion in the installed state flows better towards the cooling surface portion and thus the cooling capacity is increased.

Furthermore, according to a preferred development of the generator, it is provided that the air guide unit has a main direction of extent in the peripheral direction, and/or the air guide unit has at least one guide element, wherein preferably the at least one guide element has a deflecting portion which is designed to deflect the wind in the direction of the cooling surface portion for air cooling of the generator, and/or wherein preferably the deflecting portion is formed by a curved and/or bent guide element, and/or a plurality of guide elements are arranged offset to each other in the radial direction and/or in the axial direction. This has the advantage that the cooling effect on the generator can be adjusted in a targeted manner.

Preferably, the air guide unit comprises a plurality of air guide elements. Preferably, the plurality of air guide elements are arranged one behind the other in relation to the incident-flow direction. Additionally or alternatively, it is provided that the plurality of air guide elements are arranged distributed in the peripheral direction. Preferably, the air guide elements are arranged in a single row or in multiple rows.

In particular, it is preferred that the air guide elements can have different dimensions.

Preferably, the air unit or the one and/or more air guide elements is or are attached to the generator, in particular to the incident-flow surface portion and/or the cooling surface portion. It can be provided that the air unit or the plurality of air guide elements are connected to each other at the generator in an integrally bonded manner, in particular in a welded and/or adhesively bonded, form-fitting and/or frictionally engaged manner. In particular, the air unit or the one and/or more air guide elements are screwed to the generator, in particular to the incident-flow surface portion and/or the cooling surface portion.

Preferably, the air guide unit is provided with fastening elements spaced apart from one another in the peripheral direction, which are designed to attach the one or more air guide elements to the generator. In particular, the fastening elements can be triangular in shape. Preferably, the fastening elements have an edge against which the one or more air guide elements rest.

According to a further preferred embodiment of the generator, it is provided that the vortex generators are arranged spaced apart in the axial direction and/or in the peripheral direction.

According to a further preferred development of the generator, it is provided that the vortex generators are arranged evenly distributed on the incident-flow surface portion and/or the cooling surface portion.

The vortex generators are preferably spaced apart in the peripheral direction so that they form a ring around the generator. Preferably, the vortex generators are arranged in a single row. However, it may also be preferred that the vortex generators are arranged in several rows on the generator. In particular, the vortex generators can form several rings around the generator, spaced apart in the axial direction. The size of the vortex generators and the number of rows of vortex generators can be varied over the periphery. This can come into play in particular if, for example, a thermal out-of-roundness of the generator is to be compensated. For this purpose, the vortex generators are preferably arranged on the outer peripheral surface of the generator, in particular the outer peripheral surface of the incident-flow surface portion and/or the outer peripheral surface of the cooling surface portion. Additionally or alternatively, it is provided that the vortex generators are arranged laterally on the inner walls of possible cooling fins.

According to a further aspect, an embodiment includes a wind power installation described above comprising a generator according to the aspect described above and/or the preferred embodiments thereof described above.

According to a further aspect, an embodiment includes using a plurality of vortex generators for arrangement in a region of an outer peripheral surface portion (2), in particular in a region of an outer peripheral surface portion, in particular for arrangement in a region of an incident-flow surface portion (10) and/or in a region of a cooling surface portion (20), particularly preferably for arrangement on an incident-flow surface portion and/or on a cooling surface portion and/or an air guide unit, of a generator for a wind power installation.

For the advantages, embodiments and design details of these further aspects and developments thereof, reference is also made to the preceding description concerning the corresponding features of the generator or the respective other aspects.

Embodiments will now be described below with reference to the drawings. These are not necessarily intended to represent the embodiments to scale, but rather the drawings are executed in schematized and/or slightly distorted form where this is useful for the explanation. It should be borne in mind that a wide variety of modifications and changes concerning the shape and detail of an embodiment can be made without departing from the general concept of the present disclosure. The features disclosed in the description, in the drawings as well as in the claims may be provided both individually and in any combination. In addition, all combinations of at least two of the features disclosed in the description, the drawings and/or the claims fall within the scope of the present disclosure. The general concept of the present disclosure is not limited to the exact form or detail of the preferred embodiments shown and described below, or limited to any subject matter that would be limited compared to the subject matter claimed in the claims. In the case of stated dimension ranges, values lying within the stated limits are also intended to be disclosed as limit values and to be usable and claimable as desired. For the sake of simplicity, like reference signs are used hereinafter for identical or similar parts or parts with an identical or similar function.

### BRIEF DESCRIPTION OF THE SEVERAL VIEWS OF THE DRAWINGS

Further advantages, features and details will become apparent from the following description and from the drawings.

FIG. 1 shows a schematic, three-dimensional view of a wind power installation.

FIG. 2 shows a schematic, three-dimensional sectional view of a generator.

FIG. 3 shows a schematic, three-dimensional sectional view of a further generator based on the embodiment shown in FIG. 2.

FIG. 4 shows a schematic, three-dimensional sectional view of a further generator based on the embodiment shown in FIG. 2.

FIGS. 5a and 5b show a schematic, three-dimensional sectional view and a detailed view of a further generator.

FIGS. 6a and 6b show schematic, three-dimensional detailed views of arrangements and configurations of vortex generators on a generator.

### DETAILED DESCRIPTION

In the figures, like or substantially functionally like elements are provided with the same reference signs. General descriptions refer generally to all embodiments unless differences are explicitly stated.

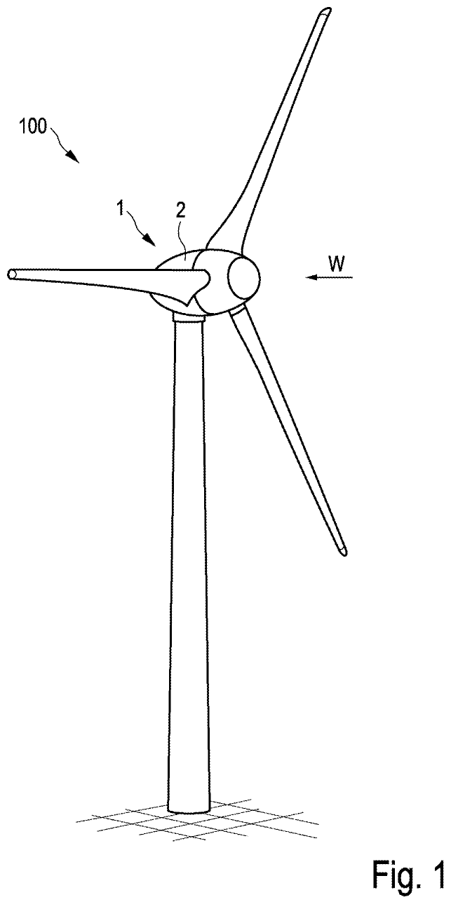

The explanation of the embodiments on the basis of examples with reference to the figures is fundamentally schematic and the elements explained in the respective figure may be exaggerated therein for better illustration and other elements may be simplified. For example, FIG. 1 illustrates a wind power installation as such schematically, and therefore the generator is not visible in detail.

FIG. 1 shows a schematic, three-dimensional view of a wind power installation 100. The wind power installation 100 has a tower 102 and a nacelle 104 on the tower 102. The tower 102 may consist here of tower segments arranged next to one another. An aerodynamic rotor 106 having three rotor blades 108 and a spinner 110 is provided on the nacelle 104. The aerodynamic rotor 106 is caused to rotate by the wind W during operation of the wind power installation 100 and thus also rotates an electrodynamic rotor of a generator 1, which is coupled directly or indirectly to the aerodynamic rotor 106. The generator 1 is arranged in the nacelle 104 and generates electrical energy.

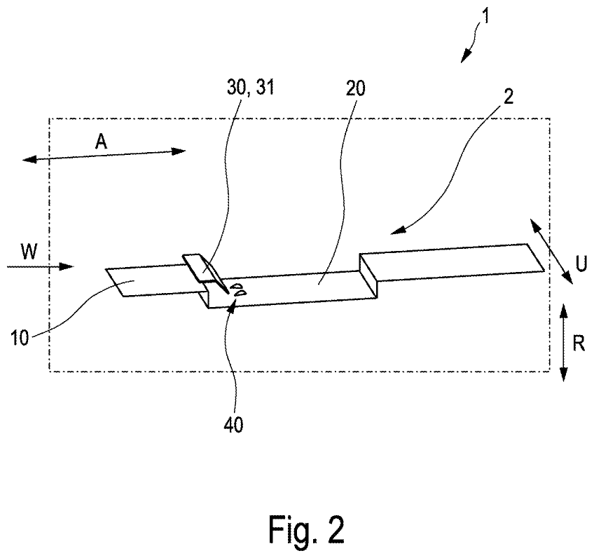

FIGS. 2 to 4 show various preferred embodiments of a generator 1. The generators 1 shown in FIGS. 2 to 4 are suitable for use in wind power installations 100 such as the one schematically shown in FIG. 1. These generators 1 are designed to generate electrical energy from kinetic energy of the wind W.

The generators 1 shown in FIGS. 2 to 4 comprise an outer peripheral surface portion 2, which has an incident-flow surface portion 10 and a cooling surface portion 20. The incident-flow surface portion 10 in this case is that surface portion of the generator 1 which the wind W flows against in an incident-flow direction in the installed state of the generator. It is provided that the incident-flow surface portion 10 extends along an axial direction A and orthogonally to the axial direction A in a peripheral direction U. The cooling surface portion 20 is arranged downstream of the incident-flow surface portion 10 in the installed state in the incident flow direction. The cooling surface portion 20, similarly to the incident-flow surface portion 10, extends along the axial direction A and orthogonally to the axial direction A in the peripheral direction U. The various embodiments of the generator 1 shown in FIGS. 2 to 4 are characterized by the fact that one or more vortex generators 40 are arranged on the incident-flow surface portion 10 and/or on the cooling surface portion 20.

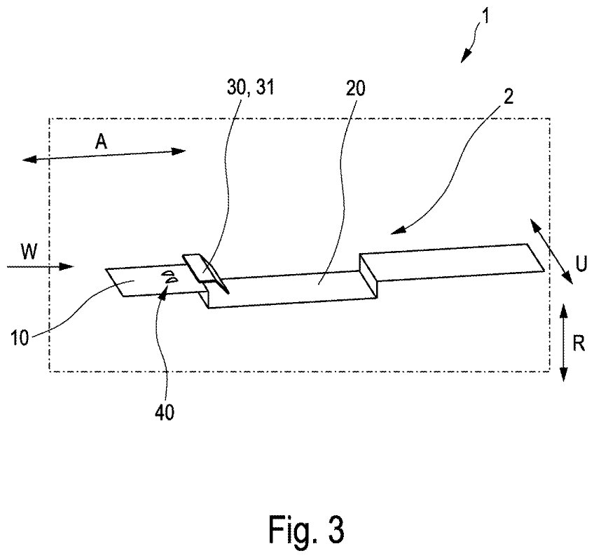

In the preferred embodiments of the generator 1 shown in FIGS. 2 and 3, it is provided that the cooling surface portion 20 is arranged offset inwards in a radial direction R relative to the incident-flow surface portion 10. Since the cooling surface portion 20 is set back inwards relative to the incident-flow surface portion 10, the transition from the incident-flow surface portion 10 to the cooling surface portion 20 is stepped.

It is further provided that the generators 1 shown in FIGS. 2 and 3 comprise an air guide unit 30. The air guide unit 30 is arranged in the region of the transition from the incident-flow surface portion 10 to the cooling surface portion 20. The air guide unit 30 is designed here in such a way that the air guide unit 30 deflects the wind W in the direction of the inwardly offset cooling surface portion 20. For this purpose, the air guide unit 30 has a main direction of extent in the peripheral direction U, so that the wind W is guided uniformly over the outer peripheral surface portion 2 of the generator 1 for cooling same. In the two preferred embodiments, it is provided that the air guide unit 30 is formed as a guide element and has a deflecting portion which is designed to deflect the wind W towards the cooling surface portion 20 for air cooling of the generator 1. The deflecting portion of the air guide unit 30 designed as a guide element is bent for this purpose.

The embodiments shown in FIGS. 2 and 3 differ substantially by the arrangement of the vortex generators 40. In the embodiment of the generator 1 shown in FIG. 2, the vortex generators 40 are arranged on the cooling surface portion 20 downstream of the air guide unit 30 in the incident-flow direction of the wind W. By contrast, in the embodiment of the generator 1 shown in FIG. 3, the vortex generators 40 are arranged on the incident-flow surface portion 10 upstream of the air guide unit 30 in the incident-flow direction of the wind W.

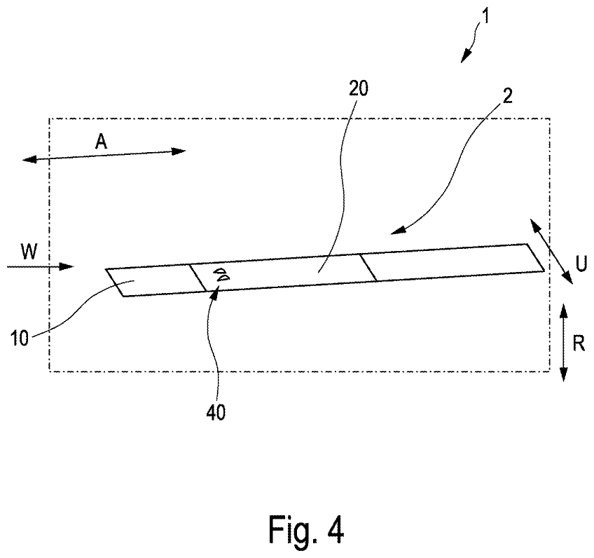

FIG. 4 shows a further preferred embodiment of a generator 1 having an outer peripheral surface portion 2. In this embodiment, it is provided that the cooling surface portion 20 and the incident-flow surface portion 10 are not offset from each other in a radial direction R. This means that the cooling surface portion 20 and the incident-flow surface portion 10 extend within the same plane. This means that the cooling surface portion 20 and the incident-flow surface portion 10 extend within the same plane. Furthermore, in this embodiment of the generator 1, no air guide unit 30 is provided to divert the wind W to the cooling surface portion 20 for cooling the generator. In this embodiment, the cooling of the generator 1 is generated solely by the vortex generators 40 arranged on the cooling surface portion 20.

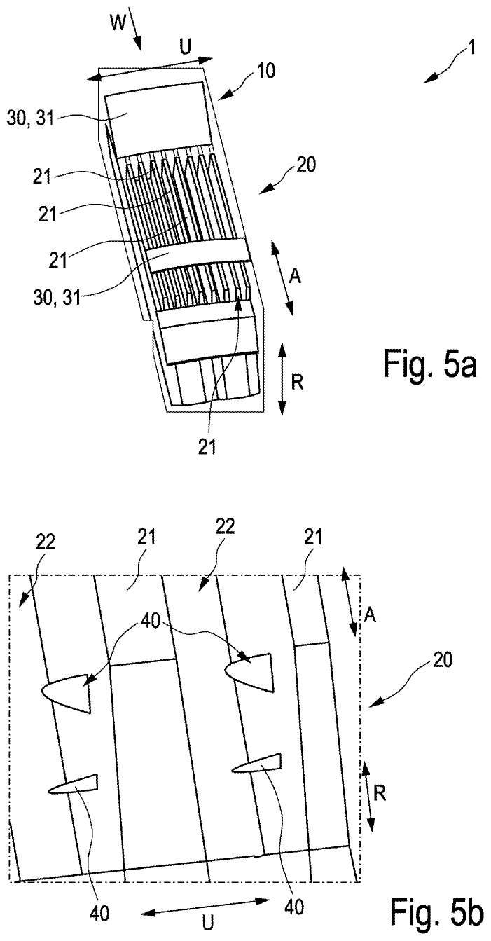

FIGS. 5a and 5b show a schematic, three-dimensional sectional view and detailed view of a further preferred embodiment of a generator 1. Here, it is provided that the cooling surface portion 20 has cooling fins 21 for cooling the generator 1. It can be seen that the cooling fins have a main direction of extent in the axial direction A, and adjacent cooling fins 21 are spaced apart in the peripheral direction so that they form a gap 22 for cooling the generator 1. It can be seen that vortex generators 40 are arranged on the cooling fins 21 and extend into the gap 22 between adjacent cooling fins 21 in the peripheral direction U. Such an arrangement of the vortex generators 40 causes a swirling of the wind W, which improves the heat dissipation and thus the cooling of the generator 1. In this preferred embodiment, this cooling effect is achieved in a special way by the double-row arrangement of the vortex generators 40 in the radial direction R.

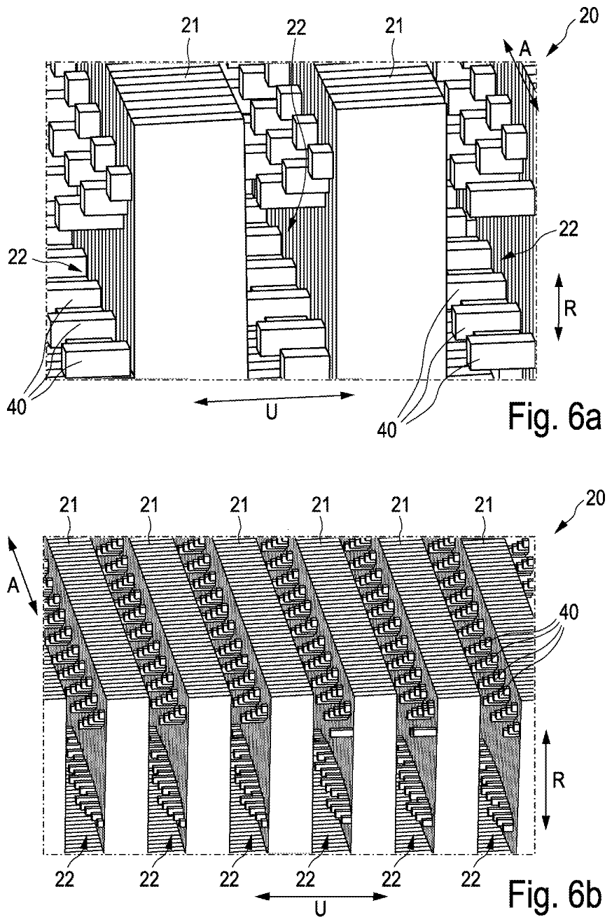

FIGS. 6a and 6b show schematic, three-dimensional detailed views of further preferred arrangements and designs of vortex generators 40 on a generator 1 in a gap 22 formed by cooling fins 21 arranged adjacently to each other in the peripheral direction U. In these two embodiments, the vortex generators are integrally formed on the laminations of the generator laminated core. It can be seen here that in the embodiment shown in FIG. 7a the vortex generators 40 are rectangular in shape. In this embodiment, it is provided that the vortex generators are arranged in four rows in the radial direction, the size of the vortex generators varying depending on the row. Furthermore, in this embodiment it is provided that the vortex generators 40 of the individual rows are arranged offset to each other in the axial direction A. The embodiment shown in FIG. 6b comprises an arrangement of vortex generators 40 in two rows in the radial direction R, the vortex generators 40 of the inner row being rectangular and the vortex generators 40 of the outer row being triangular.

### LIST OF REFERENCE SIGNS

1 generator

2 outer peripheral surface portion

10 incident-flow surface portion

20 cooling surface portion

21 cooling fins

22 gap

30 air guide unit

31 air guide element

40 vortex generators

100 wind power installation

A axial direction

R radial direction

U peripheral direction

W wind

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A generator for a wind power installation for generating electrical energy from kinetic energy, the generator comprising an outer peripheral surface portion, the outer peripheral surface portion having:
an incident-flow surface portion against which wind flows in an incident-flow direction in the installed state of the generator, the incident-flow surface portion extending along an axial direction and orthogonally thereto along a peripheral direction, and
a cooling surface portion designed for cooling the generator and disposed downstream of the incident-flow surface portion in the installed state in the incident-flow direction, the cooling surface portion extending along the axial direction and orthogonally thereto along the peripheral direction,
wherein one or more vortex generators for passive cooling of the generator are arranged in a region of the outer peripheral surface portion.

2. The generator according to preceding claim 1, wherein
one or more vortex generators for passive cooling of the generator are arranged on the incident-flow surface portion and/or on the cooling surface portion.

3. The generator according to claim 1, wherein:
the cooling surface portion is offset inwards in a radial direction with respect to the incident-flow surface portion, or
the cooling surface portion and the incident-flow surface portion are not offset from each other in the radial direction.

4. The generator according to claim 1, having an air guide unit which is arranged in the region of the incident-flow surface portion and/or in the region of the cooling surface portion, the air guide unit being designed to deflect the wind in the direction of the cooling surface portion, in a radial direction inwards towards the cooling surface portion.

5. The generator according to claim 4, wherein the one or more vortex generators are arranged on the air guide unit.

6. The generator according to claim 4, wherein the one or more vortex generators are arranged upstream of the air guide unit in the incident-flow direction.

7. The generator according to claim 4, wherein the one or more vortex generators are arranged downstream of the air guide unit in the incident-flow direction.

8. The generator according to claim 4, wherein the air guide unit is arranged in the region of a transition from the incident-flow surface portion and the cooling surface portion.

9. The generator according to claim 4, wherein:
the air guide unit has a main direction of extent in the peripheral direction, and/or
the air guide unit has at least one guide element, wherein:
the at least one guide element has a deflecting portion which is designed to deflect the wind in the direction of the cooling surface portion for air cooling of the generator, and/or wherein the deflecting portion is formed by a curved and/or bent guide element, and/or
a plurality of guide elements are arranged offset to each other in the radial direction and/or in the axial direction.

10. The generator according to claim 1, wherein the vortex generators are arranged spaced apart in the axial direction and/or in the peripheral direction.

11. The generator according to claim 1, wherein the vortex generators are arranged evenly distributed on the incident-flow surface portion and/or the cooling surface portion.

12. A wind power installation comprising a generator according to claim 1.

13. A method, comprising:
using a plurality of vortex generators in a region of an outer peripheral surface portion of a generator for a wind power installation.

14. The method according to claim 13, wherein using the plurality of vortex generators includes using the vortex generators in a region of an incident flow surface portion of the outer peripheral surface portion of the generator.

15. The method according to claim 13, wherein using the plurality of vortex generators includes using the vortex generators in a region of a cooling surface portion of the outer peripheral surface portion of the generator.

16. The method according to claim 13, wherein using the plurality of vortex generators includes using the vortex generators on an air guide unit of the outer peripheral surface portion of the generator.
